(19) United States
(12) Patent Application Publication
(10) Pub. No.: US 2026/0359448 A1
(43) Pub. Date: Nov. 12, 2026

(54) AUTOMATED SEPARATION OF LAYERS OF IMAGES OF CONTAINERIZED APPLICATIONS

(71) Applicant: ADP, Inc., Roseland, NJ (US)

(72) Inventors: Gaurav Bhargava, Roseland, NJ (US); Gilad Ofir, Cumming, GA (US); Kenneth D. Atkins, Jefferson, IN (US)

(73) Assignee: ADP, Inc., Roseland, NJ (US)

(21) Appl. No.: 19/305,482

(22) Filed: Aug. 20, 2025

Related U.S. Application Data
(60) Provisional application No. 63/803,350, filed on May 9, 2025.

(51) Int. Cl. G06F 21/57; G06F 9/455

(52) U.S. Cl. CPC G06F 21/577; G06F 9/45558; G06F 2009/45587

(57) ABSTRACT

Automated separation of layers of images from containerized applications is described. The system can utilize static and dynamic analysis of the container images. The system receives a request to determine base image information from a target image of a version of an application. Each target image includes a plurality of layers tracing back to the base image. The system uses the version of the application to identify a predetermined target image from within a digital library (e.g., container) that is associated with a base image including hash value. The system uses the hash value to determine a match between a base image extracted from the plurality of layers of the target image and the predetermined base image of the predetermined target image. The system can provide the determined base image for display on a computing device, thereby increasing available storage, reducing computing resource usage, and reducing vulnerabilities associated with security threats.

### CROSS-REFERENCE TO RELATED APPLICATION

This application claims the benefit of priority under 35 U.S.C. § 119 to U.S. Provisional Patent Application No. 63/803,350, filed May 9, 2025, which is hereby incorporated by reference herein in its entirety.

### TECHNICAL FIELD

This application is generally related to computing technology, and particularly to automated separation of layers of images of containerized applications.

### BACKGROUND

Computing systems can utilize applications to provide a variety of services to clients. These applications can include different functionalities.

### SUMMARY

Aspects of the technical solutions described herein are directed to a computing system that is designed, constructed, and operational to automatically separate layers of images of containerized applications. A containerized application can refer to or include a lightweight, standalone, and executable software package that includes all the images, which can include, for example, components, code, runtime, system tools, libraries, and settings, to run the application. A container can encapsulate an application in an isolated environments, thereby providing a consistent execution of the application across different computing environments.

However, when providing a containerized application, it can be technically challenging to identify vulnerabilities stemming from a base image when the container includes multiple application layers. Scanning, analyzing, and attempting to identify base images vulnerabilities from a target image scan result, during the build process can be challenging. Moreover trying to identify base image vulnerabilities manually can be time consuming and renders the container or computing system with errors associated with misinterpreted container images. Furthermore, the conventional methods lack scalability and robustness in the context of parameterized or multistage container images. The challenges are exacerbated as the size of the container grows exponentially, thereby causing significant increase in the time to remediate and delays in the query of base images, increasing computing cost by storing base images with errors or vulnerabilities, increasing the computing systems vulnerability to security threats from faulty base images, and increasing the unnecessary and excessive consumption of computing resources.

Aspects of the technical solutions described herein provide a system that automates the separation of base image vulnerabilities from build image vulnerabilities. The system can utilize static and dynamic analysis of the container images. The system can receive a request to determine base image information from a target image of a version of an application. Each target image can include a plurality of layers tracing back to the base image. The system can use the version of the application to identify a predetermined target image from within a digital library (e.g., container) that is associated with a base image including hash value. The system can use the hash value to determine a match between a base image extracted from the plurality of layers of the target image and the predetermined base image of the predetermined target image. Based on the determination, the system can provide the determined base image for display on a computing device. In this manner, the system can increase available storage, reduce computing resource consumption, reduce vulnerabilities associated with security threats of the base image or build image (e.g., target image), reduce the presence of vulnerable base images, and automate the separation of base image vulnerabilities from the build image vulnerabilities. Furthermore, the systems and methods described herein can provide a streamlined user interface to provide clear and concise results for addressing base image and target image vulnerabilities.

An aspect of the technical solutions described herein can be directed to a system. The system can include one or more processors coupled with memory. The one or more processors can receive a request to determine base image information used by a target image of a version of an application. The target image can include a plurality of layers. The one or more processors can identify, from a digital library based on the version of the application, responsive to the request, a predetermined target image of the version of the application. The predetermined target image can be formed from a predetermined base image associated with a first hash. The one or more processors can determine, using the first hash, a match between a base image of the plurality of layers of the target image and the predetermined base image of the predetermined target image. Responsive to the base image of the target image not matching the predetermined base image of the predetermined target image, the one or more processors can identify, from within the digital library, a subsequent target image associated with the base image information. The one or more processors can determine, using the first hash, a match between a base image of the plurality of layers of the subsequent target image and the predetermined base image of the predetermined target image The one or more processors can provide, for display on a user interface of a computing device, responsive to the request, the determined base image of the target image that matches the predetermined base image.

An aspect of the technical solutions described herein can be directed to a method. The method can include receiving, by one or more processors, a request to determine base image information used by a target image of a version of an application. The target image can include a plurality of layers. The method can include identifying, by the one or more processors from a digital library based on the version of the application, responsive to the request, a predetermined target image of the version of the application. The predetermined target image can be formed from a predetermined base image associated with a first hash. Responsive to the base image of the target image not matching the predetermined base image of the predetermined target image, the method can include identifying, by the one or more processors from within the digital library, a subsequent target image associated with the base image information.

An aspect of the technical solutions described herein can be directed to a non-transitory computer-readable medium that stores processor-executable instructions that, when executed by one or more processors, cause the one or more processors to receive a request to determine base image information used by a target image of a version of an application. The target image can include a plurality of layers. The one or more processors can identify, from a digital library based on the version of the application, responsive to the request, a predetermined target image of the version of the application. The predetermined target image can be formed from a predetermined base image associated with a first hash. Responsive to the base image of the target image not matching the predetermined base image of the predetermined target image, the one or more processors can identify, from within the digital library, a subsequent target image associated with the base image information.

These and other aspects and implementations are discussed in detail below. The foregoing information and the following detailed description include illustrative examples of various aspects and implementations and provide an overview or system for understanding the nature and character of the claimed aspects and implementations. The drawings provide illustrations and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

Aspects of the technical solutions are described in the detailed description which follows, in reference to the noted plurality of drawings by way of non-limiting examples of exemplary embodiments of the present patent application.

FIG. 1 is an illustrative example of a system for automated separation of layers of images of containerized applications.

FIG. 2 is an illustrative example of a process for automated separation of layers of images of containerized applications.

FIG. 3 is an illustrative example of a fully qualified base image.

FIG. 4 is an illustrative example of a parameterized based image.

FIG. 5 is an illustrative example of a multistage base image.

FIG. 6 depict an illustrative example of sample code to determine target image vulnerabilities.

FIG. 7 depict an illustrative example of sample code to determine base image vulnerabilities

FIG. 8 is an illustrative example of a user interface indicating one or more security vulnerabilities associated with the base image and target images.

FIG. 9 depicts an example of sample code to execute the query to determine if a vulnerability is from the base image.

FIG. 10 is an illustrative example of a table indicating a query results of the digital library.

FIG. 11 is an illustrative example of a table indicating the query results within the digital library.

FIG. 12 is an illustrative example of a method to identify the base image from the digital library.

### DETAILED DESCRIPTION

Aspects of the technical solutions described herein provide a system to automatically separate layers of images of a containerized application. The system can utilize static and dynamic analysis of the container images. The system can receive a request to determine base image information from a target image of a version of an application. Each target image can include one or more layers tracing back to the base image. The system can use the version of the application to identify a predetermined target image from within a digital library (e.g., container) that is associated with a base image including a hash value. The system can use the hash value to determine a match between a base image extracted from the one or more layers of the target image and the predetermined base image of the predetermined target image. Based on the determination, the system can provide the determined base image for display on a computing device. In this manner, the system can increase available storage, reduce computing resource consumption reduce vulnerabilities associated with security threat, reduce the presence of vulnerable base images, and automate the separation of base image vulnerabilities from the build image vulnerabilities.

In some instances, the system can receive a request to determine base image information used by a target image of a version of an application. The target image can include a plurality of layers each corresponding to an instruction including a previously created set of layers referred to as base image. The system can identify, from a digital library based on the version of the application, responsive to the request, a predetermined target image of the version of the application. The predetermined target image can be formed from a predetermined base image associated with a base image hash. The system can determine, using the base image hash, the correct base image that was used to build the target image, even in a case where there were plurality of images of the same name. The system can provide, for display on a user interface of a computing device, responsive to the request, the determined base image of the target image that matches the predetermined base image.

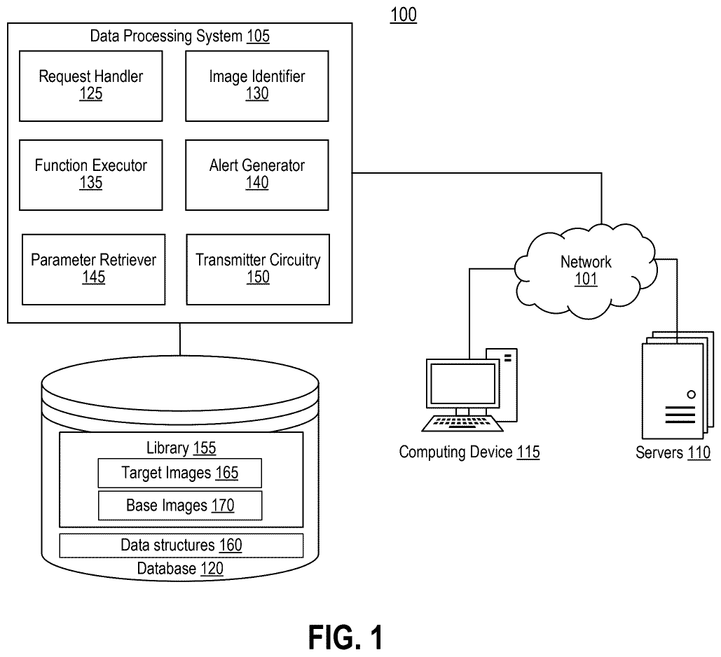

FIG. 1 is an illustrative example of a system 100 for a system to identify a base image from a digital library. The system 100 can include at least one data processing system 105, at least one server 110, at least one computing device 115, and at least one database 120. The above-mentioned components may be connected to each other through a network 101. The examples of the network 101 may include, but are not limited to, private or public Local-Area Network (LAN), Wireless Local-Area Network (WLAN), Metropolitan-Area Network (MAN), Wide-Area Network (WAN), and the Internet. The network 101 may include both wired and wireless communications according to one or more standards, or via one or more transport mediums. The system 100 is not confined to the components described herein and may include additional or alternate components, not shown for brevity, which are to be considered within the scope of the embodiments described herein.

The data processing system 105 can include at least one processor and a memory (e.g., a processing circuit). The memory can store processor-executable instructions that, when executed by processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The data processing system 105 can include one or more computing devices or servers that can perform various functions as described herein. The data processing system 105 can include any or all of the components and perform any or all of the functions of the server 110 or the computing device 115. The data processing system 105 can include one or more processors, coupled with memory. The data processing system 105 can include, access, interface with, or otherwise utilize one or more of at least one request handler 125, at least one image identifier 130, at least one function executor 135, at least one alert generator 140, at least one parameter retriever 145, or at least one transmitter circuitry 150.

In brief overview, the request handler 125 can receive requests from the computing device 115 to identify a base image within a library 155. The image identifier 130 can identify a predetermined target image 165, a predetermined based image 170, or a base image 170 from within the library 155. The function executor 135 can execute one or more functions associated with determining images or security vulnerabilities associated with the images. The alert generator 140 can generate alerts associated with one or more security vulnerabilities. The parameter receiver 145 can receive parameters from the computing device 115 or the servers 110 to remove the one or more security vulnerabilities. The transmitter circuitry 150 can transmit the base image to the computing device 115.

The servers 110 can be remote from the data processing system 105. The servers 110 can be a specialized computer or software that provides entity information, such as customer data, application data, and financial data, among others forms of data. The servers 110 can utilize to store data, facilitate applications corresponding to an application identifier or the digital library 155. The server 110 may house elements associated with the applications corresponding to the data associated with the server 110. In some instances, the servers 110 can be referred to as or include a data center, a web server, a server room, or one or more computing devices, among other forms of servers.

The computing devices 115 of the system 100 can include hardware and software components configured to perform the various processes and tasks described herein, including one or more processors or software comprising machine-executable instructions executed by the one or more processors. Non-limiting examples of such computing devices 115 of the system 100 include server computers, laptop computers, desktop computers, tablet computers, and smartphone mobile devices, among others. The computing devices 115 can execute webserver software for hosting one or more webpages according to web-related or data-communications protocols and computing languages.

The database 120 can store various types of data related to servers 110, entity data, records, computing device 115 information, among others. The data processing system 105 can access the database 120 when the one or more components of the data processing system 105 requires information (e.g., image identifier 130, function executor 135) or data to identify the base images. The database 120 can include a library 155 and one or more data structures 160. The library 155 can include one or more target images 165 and one or more corresponding base images 170 for elements of an application. The database 120 can include one or more hardware memory devices to store binary data, digital data, or the like. The database 120 can include, for example, one or more electrical components, electronic components, programmable electronic components, reprogrammable electronic components, integrated circuits, semiconductor devices, flip flops, or arithmetic units. The database 120 can include at least one of a non-volatile memory device, a solid-state memory device, a flash memory device, and a NAND memory device. The database 120 can include one or more addressable memory regions disposed on one or more physical memory arrays. A physical memory array can include a NAND gate array disposed on, for example, at least one of a particular semiconductor device, integrated circuit device, or printed circuit board device.

The library 155 can be a digital library or container that maintains one or more container files for use by the one or more servers 110. The container files can be a description, a document, or a script that include instructions to build, generate, or otherwise identify a container image. The container files can include commands and configurations that define an environment, dependencies, references, and processes to create and run various applications associated with the servers 110 or the computing device 115. The instructions can cause a computing device 115 to generate or build various images (e.g., base images 170) or image layers for each instruction. In some cases, the instructions can cause the computing device 115 to build a digital library 155. The base images 170 can be a starting point or a foundation for a container image or digital library 155. The base image 165 can be built via various programming languages and environments (e.g., python, Ubuntu, Linux, python, Java, etc.). The base image 170 can include instructions or commands to execute various applications associated with the container file or the servers 110. Each base image 170 can correspond or refer to one or more target images 165 according to one or more dependencies. Each target image 165 can be a branch or subbranch of the base image 170.

The data structures 160 can refer or correspond to one or more data objects which store, house, or otherwise maintain information associated with the base images 170 or the target images 165. The data structures 160 can include at least one of a linked list, an array, a hash (e.g., hash map, hash graph), a tree, a data table, among other data structures 160 for presentation at the computing device 115.

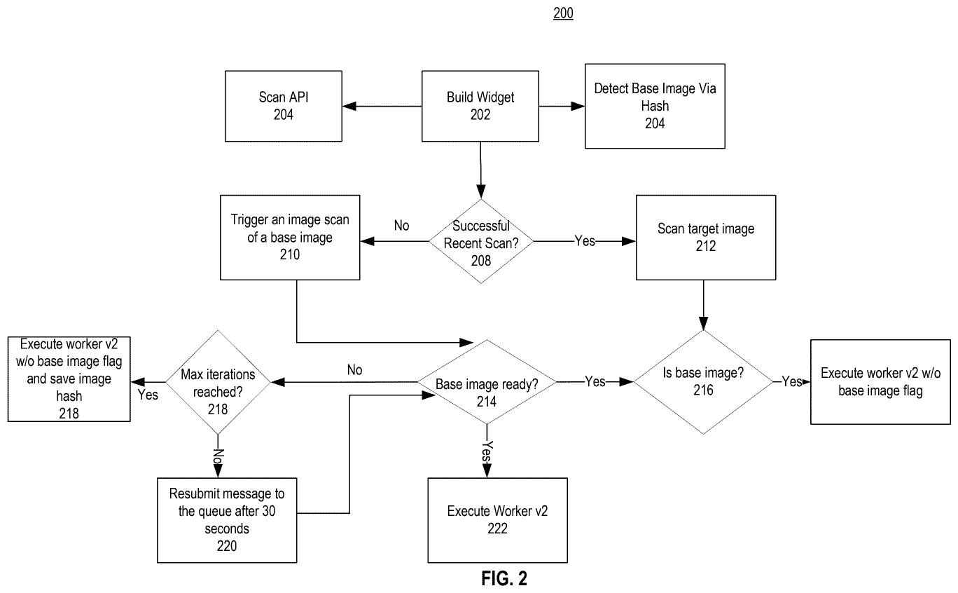

In a non-limiting example FIG. 2 is an illustrative example of a process 200 for automated separation of layers of images of containerized applications. The operations of process 200 can be performed by one or more systems or components depicted in FIG. 1, including, for example, data processing system 105. The process 200 provides a technical improvement by shifting the dependency of target image scanning on base image ingestion to the system 100 at step 202. At step 204, the system 100 can determine the base image used for the Container build operation and obtain its hash (e.g., a “sha256:” prefix). Once the base image hash is obtained, the system 100 can check the current status of the base image, at step 214. If no recent scan is found (either the base image was never scanned before, or the latest successful scan is more than 30 days old), the base image can be rescanned at step 208. If a recent successful scan is found, the base image shouldn't be rescanned. If a recent successful scan is found, the base image can be rescanned.

If the base image is rescanned at step 208, the base image can be pulled from the digital library and a library scan can be triggered at step 210. A notification or message can be sent to the computing device, and the listener can store the image hash in database. The system 100 may not wait for the base image scan to be ingested and can continue to scan the target image (e.g., target image). At step 212, the target image scan can be ingested and proceed to step 216. The system 100 can verify that the current image scan has the image hash in database at step 214, the base image scan ingestion is done (e.g., failed or successful), and the number of process retry attempts has not been reached at step 218. If any of these parameters are not met, the message can be resent to the SQS queue after a 30-second wait time at step 220, and the process retry attempt can be incremented by one then proceed to step 214. Once the verification parameters are met, the system can trigger the DIM Worker v2 step function with SaveImageHash and BaseImageFlag enabled at step 222. Examples of the process 200 can include rescanning the base image and skipping the rescanning of the base image, with links provided to specific pipeline runs. The process 200 can ensure that base images are regularly scanned and up-to-date, improving the overall security and reliability of the container images used within the process 200.

Referring to FIG. 1, among others, and in further detail, the data processing system 105 can include a request handler 125 designed, constructed and operational to receive a request for information about a base image. The request handler 125 can monitor, detect, or otherwise identify interactions between the data processing system 105 and the computing device 115. For example, the request handler 125 can receive a request from the computing device 115 responsive to, or based on, the computing device 115 inputting a command or other input into an interface of the computing device 115. For example, the computing device 115 can display a web application using one or more graphical elements. The web application can include one or more graphical user interface elements to receive or process one or more input methods and generate requests for the data processing system 105. The one or more input methods can include at least one of a mouse, a keyboard, a stylus, a controller, a sensor, among other input methods. For example, a user can use the keyboard of the computing device 115 to input information into the web application to. The request handler 125 can detect each interaction with the computing device 115 and generate metadata associated with the interactions.

The request handler 125 can receive, obtain, or otherwise retrieve a request from the computing device 115. The request can be to determine information associated with a base image (e.g., base image information) used by a target image of a version of an application. The target image of the application can include multiple layers. The request can include data associated with the interactions with the web application. The request handler 125 can receive, obtain or otherwise retrieve the request from the computing device 115 responsive to detecting an interaction. The data can include metadata, interactions, interaction times, and a container file, among other data. For example, the request can indicate a respective container file associated with at least one server 110. In some instances, the request can include base image information associated with at least one base image within the library 155. For example, the request can include the base image information which indicates one or more identifiers corresponding to a respective base image 170 within the library 155. The request can cause the data processing system 105 (e.g., request handler 125) to determine the base image information associated with a target image of a version of an application. The application can be executed on or hosted by a server 110, a collection of computing devices 115, or entity associated with the container file. Thereby, upon reception of the request, the request handler 125 can determine the application of the container file. Each of the target images 165 and the base images 170 can include a version. The version can correspond to an update, modification or change to at least one of the target images 165 and the base images 170.

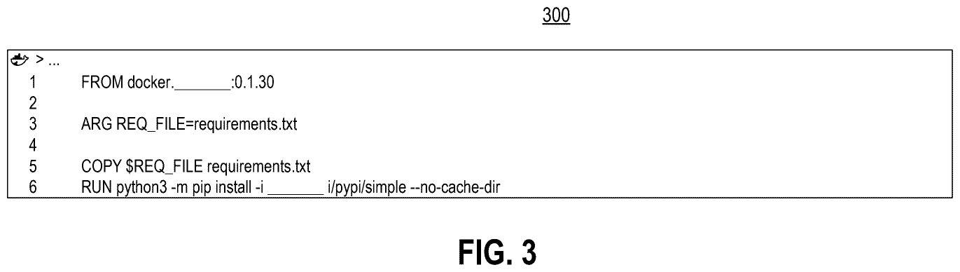

The request handler 125 can use the version of the application associated with the target image 165 to determine the base image information. The base image information can include configurations, dependencies, or references to one or more target images 165 associated with a respective base image 170. The target image 165 can use the base image information to execute one or more instructions within the container file. The target image 170 can include one or more layers that correspond to various references or dependencies from the base image 170. For example, a base image 170 can refer to a first target image 165. The first target image 165 can include one or more layers that correspond to one or more second target images 165. Each of the target images within the library 155 can include a reference to a base image within the library 155. The base image 170 can be at least one of fully qualified, parameterized, or multi-staged as shown in the various examples of FIGS. 3-5.

FIG. 3 is an illustrative example of a fully qualified base image 300. The fully qualified base image can be or correspond to a container image that is defined by a complete name (e.g., registry domain, repository tag, image name, tag, among other aspects of the complete name. The use of a fully qualified base image can reduce ambiguity and improve consistency within the library 155. The use of the fully qualified base image 300 in conjunction with the systems and methods described herein can improve security and traceability between each version of the target images.

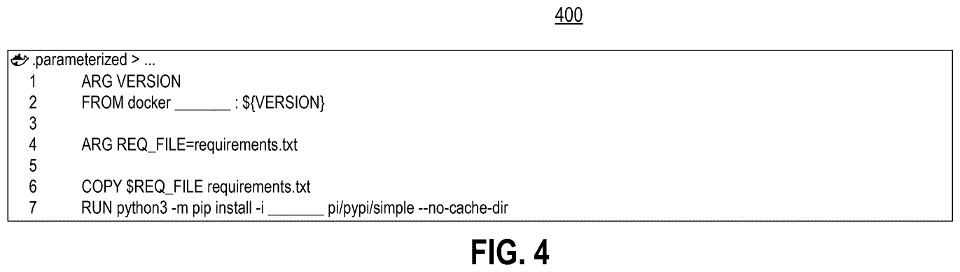

FIG. 4 is an illustrative example of a parameterized based image 400. The parameterized based image 400 can include a base image 170 that is dynamically generated using one or more scripts, functions, build-time arguments, among others. The parameterized base images 400 can allow for the use of placeholders which can be modified, updated, or changed to include a specific base image using the base image information. In this manner, the systems and methods described herein can provide containers that can be used across the servers 110.

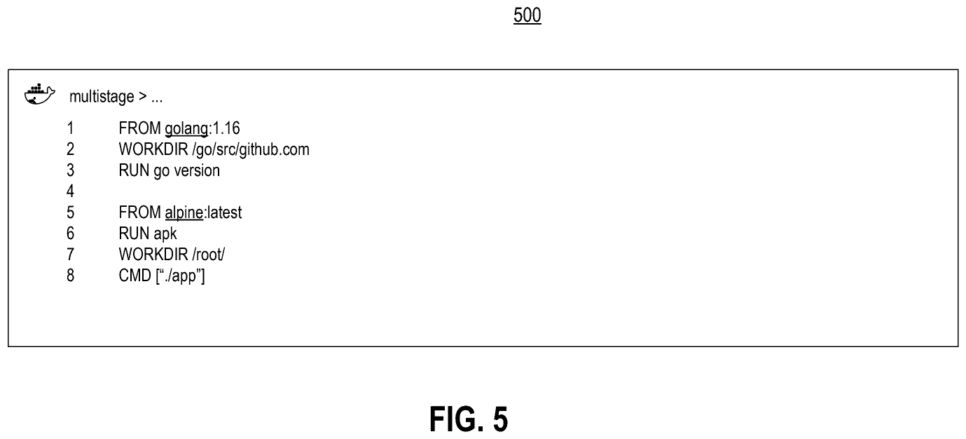

FIG. 5 is an illustrative example of multistage base image 500. The multistage base image 500 can correspond or refer to multiple stages within the container file, Each stage can include a base image and information associated with how each base image is used within the respective stage. For example, a first stage can use a base image to compile source code whereas a second stage uses a second base image that includes a compiled binary of the compiled code. The systems and methods described herein can reduce the size of base images through each stage while efficiently separating layers to improve security performance of the computing systems, and reducing overhead by including a minimum number of components (e.g., base images, target images) within a transmitted container.

The data processing system 105 can include an image identifier 130 designed, constructed and operational to identify a target image 165 of a version of the application. The image identifier 130 can identify the target image 165 from a digital library, such as library 155. The image identifier 130 can identify the target image 165 based on the version of the application. The target image can be a predetermined target image and formed from a predetermined base image associated with a first hash. The first hash can be a base image hash or a target image hash. For example, the image identifier 130 can use the base image information and the version of the application within the request to identify a predetermined target image associated with the version of the application. The predetermined target image can be a temporary target image 165 that is generated or identified by the image identifier 130 while including an associated hash (e.g., a first hash). The predetermined target image can be temporary until the resolution of the request (e.g., identification the base image, detection of a match with a target image, expiry of a timer, etc.). The predetermined target image can be generated according to the base image information received within the request. The image identifier 130 can use the base image information to generate a predetermined base image for the identification of the base image within the library 155 or the container. The associated hash can correspond to a hash of a predetermined base image. The temporary target image 165 can correspond to or match a stored target image 165 within the library 155. Subsequent to the identification of the predetermined target image, the image identifier 130 can identify or generate a predetermined or temporary base image using the base image information. In the identification, the function executor 135 can execute a protocol on the one or more layers of the predetermined target image. The protocol can be an instruction, a function, a collection of code, or a script that extrapolates each layer of the target image to trace or map the predetermined base image. Execution of the protocol can cause the function executor 135 to scan each layer of the target image to identify the first hash in accordance with the version of the application. The predetermined base image can include the first hash to indicate a potential location of the base image 170 within the library 155. In some instances, the image identifier 130 can use the predetermined base image to generate or form the predetermined target image for the version of the application.

The image identifier 130 can use the first hash of the predetermined base image 170 to determine or identify a match between a base image 170 associated with the plurality of layers of the target image 165 and the predetermined base image of the predetermined target image. In using the first hash, the image identifier 130 can query the database 120 or the library 155 to identify the respective target image 165. The library 155 or the database 120 can include the target image 165 at a location of the first hash. Using the location and the layers of the target image, the image identifier can trace or map the plurality of layers to identify the base image 170 of the target image 165.

The image identifier 130 can extract the base image 170 from the database 120 to compare against the predetermined base image. In the comparison, the image identifier 130 can match the base image information associated with the base image 170 and the base image information associated with the predetermined base image. For example, the image identifier 130 can compare the configurations within the predetermined base image and the configurations of the base image. In another example, the image identifier 130 can compare the dependencies associated with the predetermined base image and the dependencies associated with the base image. Based on the comparison, the image identifier 130 can determine the match between the base image of the plurality of layers of the target image and the predetermined base image of the predetermined target image. If the base image of the target image and the predetermined base image of the predetermined target image do not match, the image identifier 130 can identify a subsequent target image associated with the base image information. The subsequent target image can be different from the target image. Using the subsequent target image, the image identify can determine that the base image of the subsequent target image matches the base image of the predetermined target image.

The data processing system 105 can include a function executor 135 designed, constructed and operational to identify, execute or cause the execution of one or more functions, scripts, programs, or other techniques. The one or more functions can include, for example, a scan of each layer of target images, scan for base image, execute de-duplication techniques, vulnerability scans, among other functions. In further detail, a scan of each layer of a target image can involve detecting, determining, or otherwise identifying features of the target image which, trace, map, or otherwise indicate a respective base image. The scan for the base image can involve identifying a base image using the base image information within the request.

For example, the image identifier 130 can trigger the function executor 135 to execute or apply a de-duplication function or technique on the target image and the predetermined target image. The de-duplication function can query the library 155 to identify duplicate records of a respective target image or base image. The de-duplication technique can be at least one of primary key constraints, distinct keyword, group by clause, self-join, among other functions. The function executor 135 can execute the de-duplication technique responsive to the identification of the predetermined target image 165. The execution of the de-duplication technique can generate a result which indicates a match between a base image 170 of the target image 165 and the predetermined base image of the predetermined target image. In this manner, the use of the de-duplication functions can reduce memory and storage within the container by identifying matches and disregarding any predetermined images (e.g., target images, base images). Furthermore, the use of the de-duplication functions can be portable across various systems and environments while increasing the speed of lookups (e.g., cache, RAM). By localizing the de-duplication function within the container, the system and methods described herein can avoid redundancy at the container level and environment level.

The data processing system 105 can include an alert generator 140 designed, constructed and operational to generate an alert, warning, notification, or other indication. For example, upon identification of the base image 170, the alert generator 140 can identify one or more security vulnerabilities indicating a threat level associated with each of the plurality of target images. The one or more security vulnerabilities can indicate or correspond to a weakness associated with the computing device 115 or the servers 110 that can be exploited by an attack from one or more malicious actors. The security vulnerabilities can occur in response to coding errors, misconfigurations, design flaws, among other issues with the container. The security vulnerabilities can include at least one of buffer overflow, SQL injection, cross-site scripting, cross-site request forgery, weak authentication, misconfigurations, insecure application programming interfaces, unpatched software, among others.

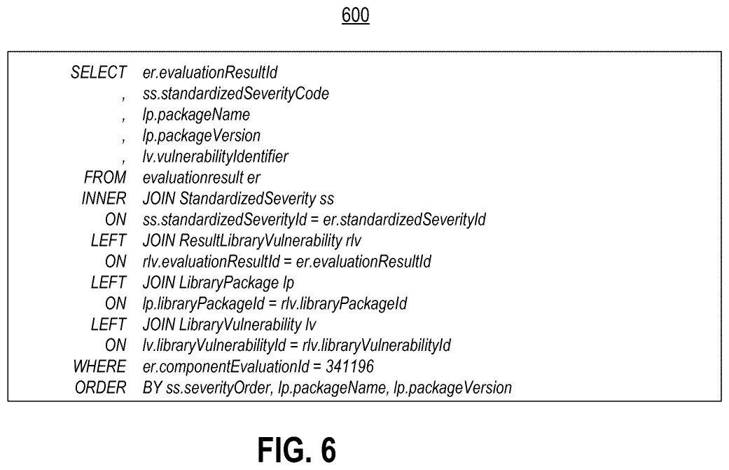

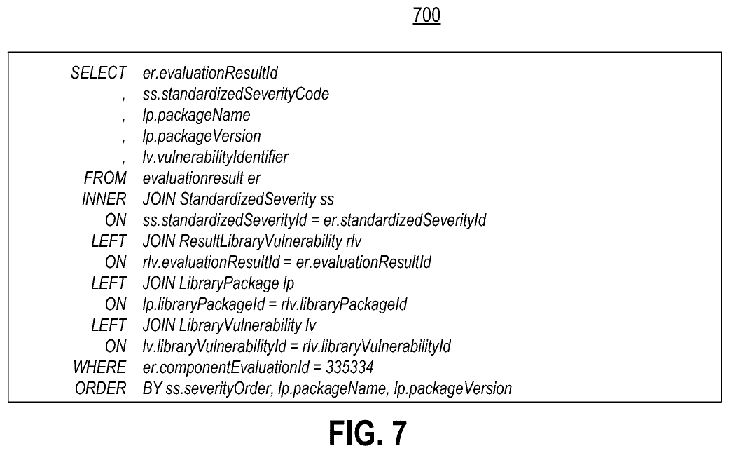

Each of the one or more security vulnerabilities can be associated with a threat level. The threat level can indicate an urgency to resolve the one or more security vulnerabilities. The threat level can be conveyed using categories, numeric scores, letter grades, colors, or other symbols. For example, the threat level can correspond to at least one of critical, high, medium, or low. The threat level can correspond to a numerical value on a scale of 1 to 10 or 1 to 100, or any other scale, with 1 indicates the lowest threat level and 10 indicating the highest threat level, or vice versa. The security vulnerabilities and the threat level can be assigned to each target image 165 and the base image 170. The alert generator 140 can identify the one or more security vulnerabilities by executing a vulnerability scan on each of the plurality of target images. The alert generator 140 can generate an alert according to the threat level of each of the one or more security vulnerabilities for each of the plurality of target images 165. The alert can be at least one of an audible alert, visual alert, indication, notification, message, among other alerts. FIG. 6-7 depict examples of sample code to determine target image vulnerabilities 600 and base image vulnerabilities 700.

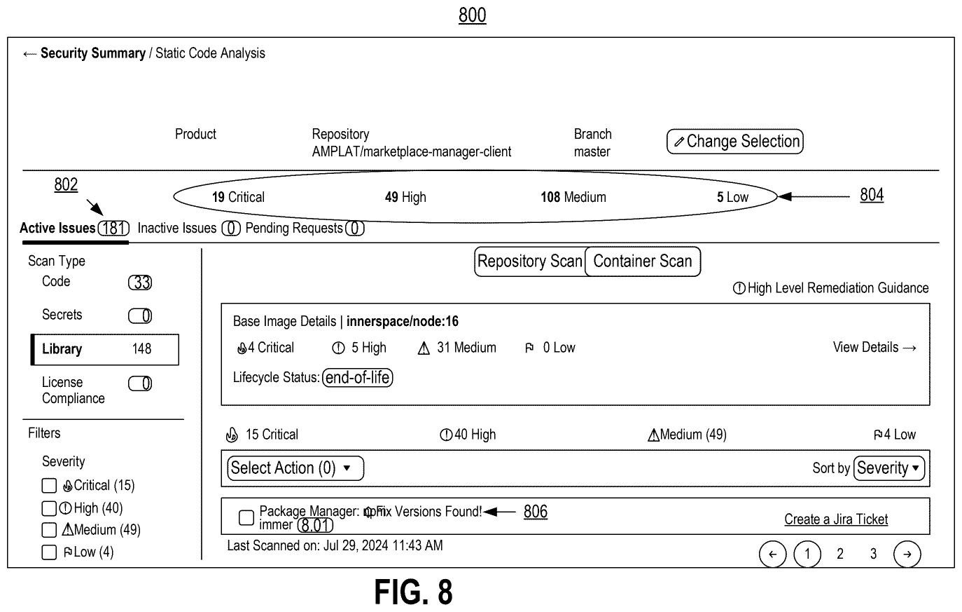

The data processing system 105 can include transmitter circuitry 150 designed, constructed and operational to transmit various instructions via network 101 to one or more computing devices 115 or servers 110. The transmitter circuitry 150 can provide the determined base image 170 for display on a user interface of the computing device 115. The transmitter circuitry 150 can transmit instructions to the computing device 115 to cause the computing device 115 to display the determined base image 170. The instructions can include processing instructions for display of the determined base image 170 based on user interface (UI) elements of the computing device 115. The UI elements can correspond to visual components of the user interface of the computing device 115, such as a command button, a text box, a check box, a radio button, a menu item, and a slider, among others visual components. In some instances, the transmitter circuity 150 can provide a user interface for display on the computing device as shown in FIG. 8.

FIG. 8 is an illustrative example of a user interface 800 indicating one or more security vulnerabilities associated with the base image and target images. The user interface 800 can display one or more information associated with the base image 170 and the target images 165. For example, the user interface 800 can display one or more vulnerabilities 802 associated with each target image 165 and the base image 170. The user interface 800 can display the threat level 804 associated with each target image or base image. As shown in FIG. 8, the threat levels 804 can indicate “critical”, “high”, “medium”, or “low”. The user interface 800 can display the threat levels associated with each target image 165 or base image 170. Within the display, the user interface 800 can further indicate a number of versions that are associated with the one or more vulnerabilities as shown by the alert 806. The transmitter circuitry 150 can provide the alert for display on the user interface as shown in FIG. 8. The alerts can correspond to or indicate the threat level for each target image and the base image.

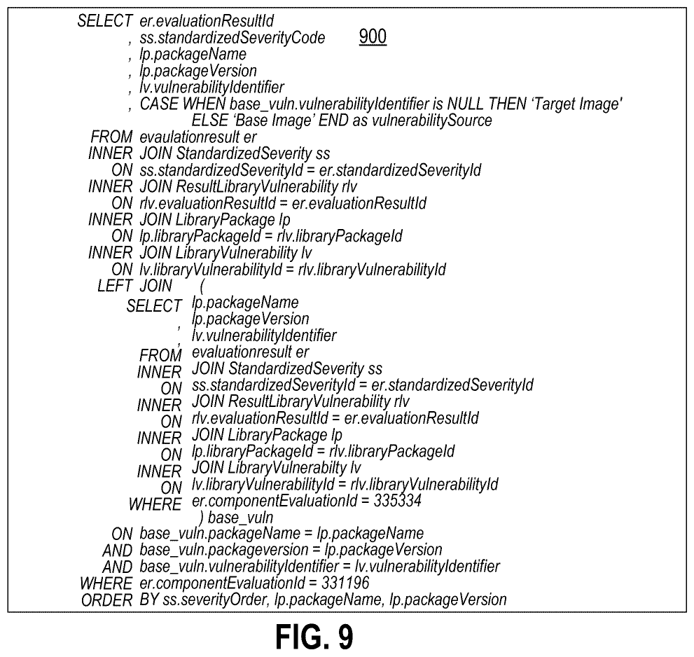

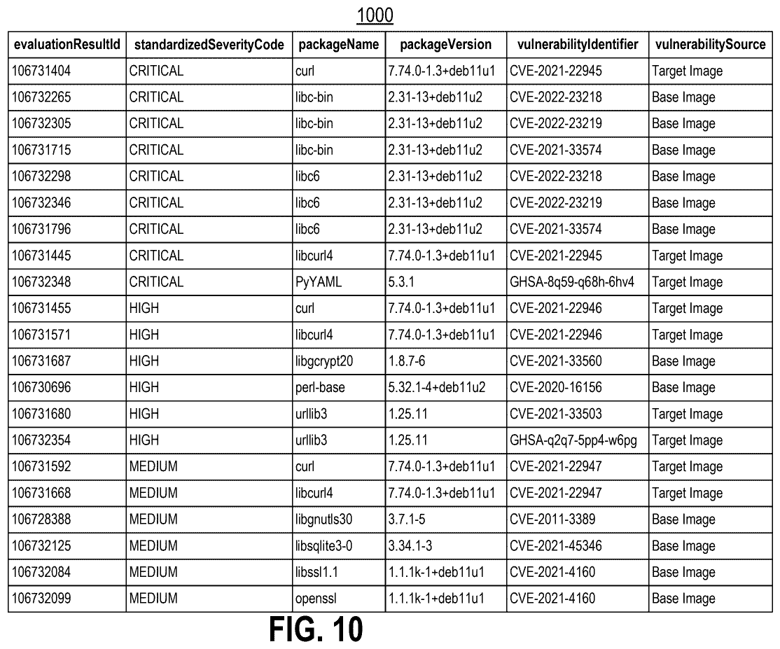

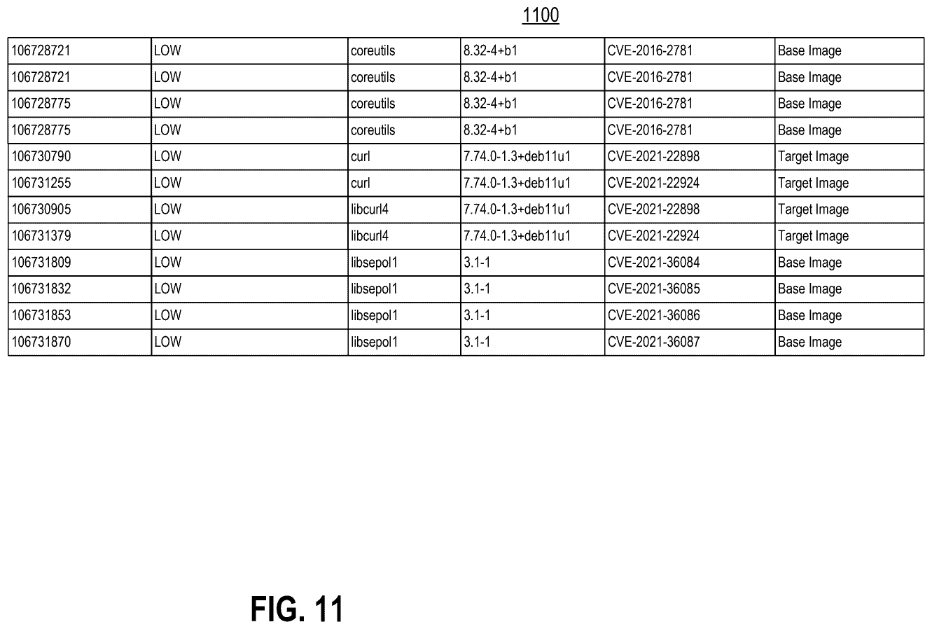

The function executor 135 can execute a query on each target image 165 within the library 155. FIG. 9 depicts an example of sample code to execute the query 900 query to determine if a vulnerability is from the base image. The query 900 can determine that the one or more security vulnerabilities are associated with the base image in response to the determination of the base image 170 based on the execution of the vulnerability scan on the base image 170. From here, the alert generator 140 can identify a threat level associated with the base image 170. The alert generator 140 can identify an amount for the one or more security vulnerabilities of each target image 165 and each base image 170 within the container file in the library 155. The alert generator 140 can generate the data structure 160 based on the result of the query 900. The alert generator 140 can generate the data structure 160 to include each amount of the one or more security vulnerabilities associated with the target images 165 and the base images 170. The data structure 160 can be a data table 1000 or 1100, as shown in FIG. 10 and FIG. 11, respectively, that includes each security vulnerability of the associated threat levels of the target images 165 and the base images 170. The alert generator 140 can further identify a source of a respective security vulnerability associated with the target image 165. For example, the source of a security vulnerability in a first target image 165 can be a second target image 165. In another example, the source of the security vulnerability in a target image 165 can be the base image 170. The data table 1000 and 1100 can further include the version of the application associated with each base image 170 or target image 165.

The transmitter circuitry 150 can transmit, send, or otherwise provide the data structure 160 or the second data structure 160 to the computing device 115. The alert generator 140 can trigger the transmitter circuity 150 to transmit the data structure 160 in response to the generation of the data structure 160. For example, responsive to the generation of the alert, the transmitter circuitry 150 can transmit the data structure 160 to the computing device 115. Concurrently, the transmitter circuitry 150 can store the data structure 160 within the plurality of data structures 160 within the database 120.

The computing device 115 can receive the data structure 160, the instructions to generate the user interface 800, and the alerts from the data processing system 105. Upon receipt, the computing device 115 can allow a user to review the base images 170, the target images 165, and the one or more security vulnerabilities. The user interface 800 can provide one or more UI elements to receive feedback from the computing device 115. The feedback can include parameters to remove the security vulnerabilities from the target images 165 and the base images 170.

The data processing system 105 can include a parameter retriever 145 designed, constructed and operational to do receive or retrieve feedback via the network 101 from the computing devices 115 associated with the security vulnerabilities. The parameter retriever 145 can retrieve or receive, from the computing device 115, one or more parameters. The one or more parameters can be test scripts, instructions, or data packets that are configured to remove one or more security vulnerabilities associated with the threat level. In some instances, the parameters can be received in accordance with a priority. The priority can correspond or refer to the threat level. Upon reception of the parameters, the function executor 135 can remove the one or more security vulnerabilities from the base images 170. In some instances, the function executor 135 can remove the one or more security vulnerabilities from the target images 165. In this manner, the data processing system 102 can reduce or eliminate the threat level associated with the one or more security vulnerabilities.

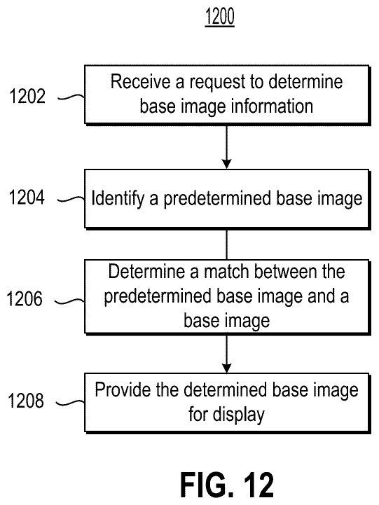

FIG. 12 is an illustrative example of a method 1200 to identify base images. The method 1200 can be performed by one or more processors (e.g., data processing system 102). The method 1200 can be performed by one or more components depicted in FIG. 1. At step 1202, the one or more processors can receive a request to determine base image information used by a target image of a version of an application. At step 1204, the one or more processors can identify a predetermined target image of the version of the application from a digital library based on the version of the application, responsive to the request. The predetermined target image can be formed from a predetermined base image associated with a first hash. At step 1206, the one or more processors can determine a match between a base image of the plurality of layers of the target image and the predetermined base image of the predetermined target image using the first hash. At step 1208, the one or more processors can provide the determined base image of the target image that matches the predetermined base image, for display at the user interface of the computing device 115.

In this manner, the systems and methods described herein can provide a robust system designed to automate the separation of base image vulnerabilities from build image vulnerabilities y. This system utilizes both static and dynamic analysis to determine base image information from a target image of a version of an application. By doing so, it can increase available storage, reduce computing resource consumption and minimize vulnerabilities associated with security threats. Additionally, it reduces the presence of vulnerable base images and reduces time to address the base image or target image vulnerabilities, which can otherwise lead to increased computing resource consumption and security risks.

The systems and methods described herein improve computing systems by addressing the inefficiencies and limitations of prior methods. Scanning and analyzing container images are often static and time-consuming, leading to errors and misinterpretations of container images. These methods lack scalability and robustness, especially when dealing with parameterized or multistage container images. As the size of the container grows, these challenges are exacerbated, causing significant delays in querying base images, increasing computing costs, and wasting computing resources. The systems and methods described herein overcomes these issues by providing a more efficient and scalable solution, ultimately enhancing the overall security and performance of the system. Furthermore, the systems and methods described herein allow for remedial actions in real time to resolve the one or more security vulnerabilities.

The foregoing examples have been provided merely for the purpose of explanation and are in no way to be construed as limiting of the present description. While aspects of the present description have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present description in its aspects. Although aspects of the present description have been described herein with reference to particular means, materials and embodiments, the present description is not intended to be limited to the particulars disclosed herein; rather, the present description extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encode in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and cannot be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including one or more these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present description.

What is claimed is:

1. A system, comprising:
one or more processors, coupled with memory, to:
receive a request to determine base image information used by a target image of a version of an application, the target image comprising a plurality of layers each corresponding to a base image, the base image including one or more functions to execute each of the plurality of layers of the target image;
identify, from a digital library based on the version of the application, responsive to the request, a predetermined target image of the version of the application, the predetermined target image formed from a predetermined base image associated with a first hash;
determine, using the first hash, a match between a base image of the plurality of layers of the target image and the predetermined base image of the predetermined target image;
responsive to the base image of the target image not matching the predetermined base image of the predetermined target image, identify, from within the digital library, a subsequent target image associated with the base image information; and
determine, using the first hash, a match between a base image of the plurality of layers of the subsequent target image and the predetermined base image of the predetermined target image and
provide, for display on a user interface of a computing device, responsive to the request, the determined base image of the subsequent target image that matches the predetermined base image.

2. The system of claim 1, wherein the one or more processors further:
execute, using the first hash, a de-duplication technique on the target image and the predetermined target image; and
determine the match between a base image of the target image and the predetermined base image of the predetermined target image based on a result of the de-duplication technique.

3. The system of claim 1, wherein the one or more processors further:
determine, via execution of a protocol on one or more layers of the predetermined target image, using the first hash, a predetermined base image that includes the first hash.

4. The system of claim 3, wherein the protocol scans each layer of the application to identify the first hash in accordance with the version of the application.

5. The system of claim 1, wherein each of a plurality of target images includes a reference to the base image within the digital library wherein, and to identify the predetermined target image of the version of the application, the one or more processors further:
identify the predetermined based image in accordance with the reference included within the predetermined target image.

6. The system of claim 5, wherein the one or more processors further:
identify one or more security vulnerabilities indicating a threat level associated with each of the plurality of target images by executing a vulnerability scan on each of the plurality of target images;
generate an alert according to the threat level of each of the one or more security vulnerabilities for each of the plurality of target images; and
provide, for display on the user interface of the computing device, the alert.

7. The system of claim 6, wherein the one or more processors further:
execute a query on each target image to determine whether the one or more security vulnerabilities are detected within the base image;
generate a data structure to include a result of the query; and
provide, for display on the user interface, the data structure.

8. The system of claim 1, wherein the one or more processors further:
identify a threat level for the base image determined from execution of a vulnerability scan on the base image;
generate an alert according to the threat level for the base image; and
provide, for display on the user interface of the computing device, the alert.

9. The system of claim 8, wherein the one or more processors further:
receive, from the computing device, a parameter configured to remove one or more security vulnerabilities associated with the threat level; and
remove, based on the parameter, the one or more security vulnerabilities from the base image.

10. The system of claim 1, wherein the one or more processors further:
identify a first amount of one or more security vulnerabilities associated with the base image;
identify a second amount for the one or more security vulnerabilities associated with a plurality of target images;
generate a data structure including the first amount and the second amount for the one or more security vulnerabilities; and
provide, for display on the user interface of the computing device, the data structure.

11. The system of claim 1, wherein each of a plurality of target images and the base image include metadata corresponding to a source computing device, each version of the application, and the first hash associated with the base image.

12. The system of claim 1, wherein the base image is at least one of fully qualified, parameterized, or multi staged.

13. A method of determining base images, comprising:
receiving, by one or more processors, a request to determine base image information used by a target image of a version of an application, the target image comprising a plurality of layers each corresponding to a base image, the base image including one or more functions to execute each of the plurality of layers of the target image;
identifying, by the one or more processors from a digital library based on the version of the application, responsive to the request, a predetermined target image of the version of the application, the predetermined target image formed from a predetermined base image associated with a first hash; and
responsive to the base image of the target image not matching the predetermined base image of the predetermined target image, identifying, by the one or more processors, from within the digital library, a subsequent target image associated with the base image information.

14. The method of claim 13, further comprising:
executing, by the one or more processors using the first hash, a de-duplication technique on the target image and the predetermined target image; and
determining, by the one or more processors, the match between a base image of the target image and the predetermined base image of the predetermined target image based on a result of the de-duplication technique.

15. The method of claim 13, further comprising:
determining, by the one or more processors executing a protocol on one or more layers of the predetermined target image, using the first hash, a predetermined base image that includes the first hash.

16. The method of claim 15, wherein the protocol scans each layer of the predetermined target image to identify the first hash in accordance with the version of the application.

17. The method of claim 13, wherein each of a plurality of target images includes a reference to the base image within the digital library, wherein identifying a predetermined target image of the version of the application further comprises identifying, by the one or more processors, the predetermined based image in accordance with the reference included within the predetermined target image.

18. The method of claim 17, further comprising:
identifying, by the one or more processors, one or more security vulnerabilities indicating a threat level associated with each of the plurality of target images by executing a vulnerability scan on each of the plurality of target images;
generating, by the one or more processors, alerts according to the threat level of each of the one or more security vulnerabilities for each of the plurality of target images; and
provide, for display on the user interface of the computing device, the generated alerts.

19. A non-transitory computer readable medium comprising instructions that when executed by one or more processors, cause the one or more processors to:
receive a request to determine base image information used by a target image of a version of an application, the target image comprising a plurality of layers each corresponding to a base image, the base image including one or more functions to execute each of the plurality of layers of the target image;
identify, from a digital library based on the version of the application, responsive to the request, a predetermined target image of the version of the application, the predetermined target image formed from a predetermined base image associated with a first hash;
determine, using the first hash, a match between a base image of the plurality of layers of the target image and the predetermined base image of the predetermined target image; and
provide, for display on a user interface of a computing device, responsive to the request, the determined base image of the target image that matches the predetermined base image.

20. The non-transitory computer readable medium of claim 19, wherein the instructions further cause the one or more processors to:
identify a first amount of one or more security vulnerabilities associated with the base image;
identify a second amount for the one or more security vulnerabilities associated with a plurality of target images;
generate a data structure including the first amount and the second amount for the one or more security vulnerabilities; and
provide, for display on the user interface of the computing device, the data structure.
